(19) United States
(12) Patent Application Publication
(10) Pub. No.: US 2010/0042851 A1
(43) Pub. Date: Feb. 18, 2010

(54) Method for Securely Handling Data During the Running of Cryptographic Algorithms on Embedded Systems

(75) Inventors: Benoit Chevallier-Mames, Cassis (FR); Mathieu Ciet, La Ciotat (FR); Karine Villegas, Gemenos (FR); Jacques Fournier, Marseille (FR)

Correspondence Address: BUCHANAN, INGERSOLL & ROONEY PC, POST OFFICE BOX 1404, ALEXANDRIA, VA, 22313-1404, US

(73) Assignee: GEMPLUS, Gemenos (FR)

(21) Appl. No.: 12/084,487

(22) PCT Filed: Oct. 27, 2006
(86) PCT No.: PCT/EP2006/067901

§ 371 Date: May 23, 2008

(30) Foreign Application Priority Data
Nov. 4, 2005 (FR) 0511268

(51) Int. Cl. G06F 12/14

(52) U.S. Cl. 713/193

(57) ABSTRACT

The invention relates to a method for handling data between two memory areas of an electronic component having at least one working memory area for carrying out operations on the component, which bring into play at least some of the data. The same memory areas are used for executing an operation, whatever the operation to be executed is, in such a manner that each operation has a hidden signal trace that is identical in terms of location leakage outside the component.

The present invention relates to a method for blocking covert channel attacks during the handling of data, typically during the execution of cryptographic algorithms on an electronic component. These can be secret-key or public-key algorithms.

Such components are more particularly used in applications in which access to services or to data are checked, such as cryptographic applications.

Such components have a programmable architecture formed around a microprocessor and memories, among which a volatile programmable memory or a non-volatile memory which contains one or more secret data; this is a generalist architecture capable of executing any algorithm.

Such components are used in computer systems whether embedded or not; they are more particularly used in chip cards, for some applications thereof. These are, for example, bank applications, applications for a mobile telephone comprising, for example SIM cards, remote payment applications, for example for television, etc.

Such components or such cards, thus carry out a cryptographic algorithm to perform the ciphering of a message (when the latter must remain confidential) or the authentication or the digital signature of a message (when the non-repudiation is desired).

Starting from this message applied as an input into the card through the host system (server, bank dispensing machine) and secret Figures contained in the card, the card supplies in return the host system with this ciphered or signed message which makes it possible, for example, for the host system to authentify the component or the card or to exchange data.

The safety of such cryptographic algorithms resides in the secret number or numbers contained in the card and unknown to the world outside the card as well as in the way such secret numbers are used.

Now, it appeared that external attacks based on physical variables measurable from outside the component when the latter is executing the cryptographic algorithm, make it possible for malevolent third parties to find the secret number or numbers or data contained in the card. Such attacks are called side channel analysis and take into account the existence of an additional channel through which the information can leak. The physical signals used are more particularly the electromagnetic radiation, the electric consumption or the computing time of the component.

Among such side channel analyses, the SPA attacks, which means Simple Power Analysis, which are based on one or a few measures and the DPA attacks, which means Differential Power Analysis, based on statistic analyses resulting from several measurements can be distinguished. Such attacks are based, for example, on the fact that the electric power consumption of the microprocessor which is carrying out instructions varies depending on the handled instruction or data.

During the handling of data for the execution of functionalities playing a part in the execution of cryptographic algorithms, it is possible for a hacker to know which register or registers has or have been used by localising active or not-active memory areas (for example, if the addresses of the data leak in terms of current or from an electromagnetic point of view). The hacker can thus take advantage of such information to use secrets or functionalities to which access is denied.

Conventionally, as a protection against such attacks, the methods used in the prior art most often provide, for a given operation, to plan several embodiments for such operation and to carry out such operation by randomly using one of the embodiments planned. The objective is to confuse the issue by multiplying the ways the same operation can be executed, so that the various embodiments involve different forms of hidden signals (or signatures or traces) as regards the leakage of information to the outside.

For example, in the case where data are copied into a working memory area for executing some functionality, it can be planned to have access to the words of the data to be copied in a random way and to copy the words accessed to into the working memory, in any order, depending on a random variable. However, if such a method makes it possible to avoid attacks of the dictionary type, it is not adapted to high level attacks which, for example, take advantage of the address leakages of the components or more particularly give the possibility of distinguishing whether the areas of the memory are active or not. Thus, from the outside, it is finally possible, when using such type of attack, to know which data have been copied into the working memory area and to derive whole or part of the secrets thereof.

The claimed invention remedies such disadvantage and provides an alternative method for the secure handling of data during the running of cryptographic algorithms on an electronic component, whether portable or not, which makes it possible to prevent covert channel attacks, more particularly those which are based on an address leakage of the components or on a distinction of active or non-active memory areas, with a view to derive therefrom the functionalities which are operated in the card.

The invention, thus relates to a method for handling data between memory areas of an electronic component comprising at least a working memory area for carrying out operations on said component bringing into play at least one of said data, said method being characterised in that it includes using the same memory areas for carrying out an operation, whatever the operation to be executed is, in such a manner that each operation has a hidden signal trace that is identical in terms of location leakage outside this component.

According to one embodiment, the method includes, prior to the carrying out of the operation, a step of configuring the memory areas to be used with the data used as operands in said operation, said step of configuration of the memory areas depending on the operation to be executed.

Advantageously, the step of configuring the memory areas consists in copying one of said data into the working memory area, the copying of said data being hidden and random during the execution thereof.

Advantageously, the memory areas containing said data are simultaneously active during the copying of one of said data into the working memory area.

According to one embodiment, the copying of one of said data into the working memory area consists in successively accessing, in an order which depends on a random variable, said elements of said data in the respective memory areas thereof and in copying said elements into the working memory area while replacing one of the data elements by the data element corresponding to the data to be copied into the working memory area.

According to one embodiment, the operations carried out are operations executed within the scope of the execution of a public-key cryptographic algorithm.

Preferably, the public-key cryptographic algorithm is of the RSA type, and the operations are square and multiplication operations used for the modular exponentiation.

According to one embodiment, the method is hardware-executed.

The invention also relates to a system for the implementation of the method according to any one of the preceding claims, wherein the component is a chip card, a chip card reader or a TPM (Trusted Platform module).

Other characteristics and advantages of the present invention will appear more clearly while reading the following description, which is given as an illustrative and not limitative example, and refers to the following single Figure:

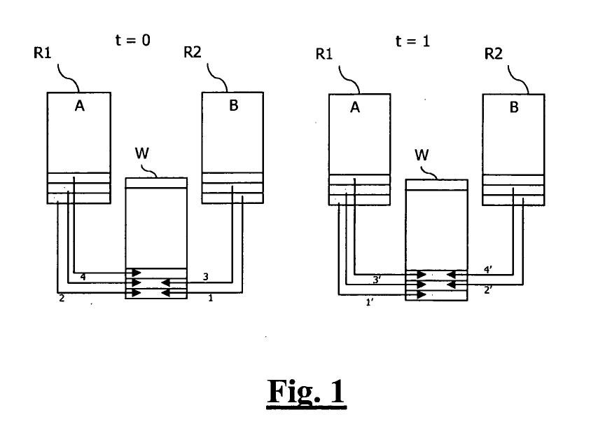

FIG. 1, which is a schematic representation of various memory areas of a chip card illustrating the principle of the invention.

The general principle, on which the invention is based, consists in finding alternative embodiments of several different operations so that such alternatives have the same “trace” outside the electronic component in which they are executed as regards the address or location leakages of the active or non-active areas. In this case, the respective alternatives of the various operations cannot be separated from each other which results in the fact that an outside observer does not know which operation is effectively executed on the component. Typically and generally, the operation of copying a first or a second data into a working area of the memory will be carried out so that a hacker capable of determining and distinguishing the accesses to the first and to the second data will not be able to recognise which data have effectively been stored in the working area.

According to the invention, it is also provided to use the same memory areas all the time to make the calculations involved in the current operations so as to limit the accesses to the memories and to prevent the address leakages. More particularly, a common working memory area is provided, where the operands required for carrying out the operation are copied on the fly.

FIG. 1 thus shows such a working memory area W as well as two memory areas R1 and R2 containing values to be treated A and B. To block certain possible attacks of the above-mentioned type, copying data into the working memory area is hidden and random as regards its execution, whereas the computational part is planned to be always the same as regards the information leakages to the outside.

The method for copying data A, for example, into the working memory area W consists in successively accessing the words A and B, as a function of a random variable t. In this way, during the copying of the data A into W, the memory areas R1 and R2 which respectively contain the data A and B are simultaneously active in an order which can vary depending on the random variable. It results therefrom that, from the outside, it is impossible to know whether the data from the memory area R1 or R2 have been copied into W at the end of the copying process.

FIG. 1 more particularly illustrates a diagram of the algorithm used for copying data A into the working register W according to the above-mentioned principles.

Let A=Aₖ₋₁∥ . . . ∥A₀, B=Bₖ₋₁∥ . . . ∥B₀ and W=Wₖ∥Wₖ₋₁∥ . . . ∥W₀, where ∥ corresponds to concatenation, and where Xᵢ correspond to the words of the variable X. Besides, let t be a random bit,

If t=0

a) for j=0 to k−1
i) Wⱼ←Bⱼ; Wⱼ←Aⱼ

b) Wₖ←0

If t=1

a) for j=0 to k−1
Wⱼ←Aⱼ; Wⱼ₌₁←Bⱼ

b) Wₖ←0

The algorithm would work in a similar way for copying data B into W and in the same way it would be impossible to make the distinction between the copy of A into W and the copy of B into W since the random variable t defines the order of access to such or such register first.

Thus, referring again to the example of the copy of A into W, depending on the value 0 or 1 of the random variable t, the memory area R1 or R2 is first accessed but in both cases, in the end the value A is copied into W. As a matter of fact, the algorithm provides that upon each loop cycle, the value Bⱼ is replaced by the value Aⱼ.

So if t=0 the value Bⱼ is written first into Wⱼ (a step symbolised by the arrow 1 in the FIG. 1) then Wⱼ takes the value Aⱼ which thus replaces the value Bⱼ previously written into Wⱼ (arrow 2) and so on upon each cycle of the loop of the algorithm.

In the case where t=1, Wⱼ first takes the value Aⱼ (such as symbolised by the arrow 1′), whereas Wⱼ₊₁ takes the value Bⱼ (arrow 2′). Then, during the next loop cycle, j has been incremented and the previously copied value Bⱼ is replaced by the new value Aⱼ (arrow 3′). The copy can, of course, be made in a non-linear way, i. e. by randomly selected blocks.

As described hereabove, the loop implemented in the copying algorithm of j=0 to j=k−1 is run. According to an alternative, the algorithm can be executed in the reverse direction by decrementing j without modifying the result. Besides, the algorithm can be operated with words having any size.

In both cases, the final value that was desired as a copy, i.e. data A, is obtained, finally in the working memory area W. The random variable t makes it possible, in an advantageous way, to have two different ways of copying A into W, since, depending on the value of the random variable, A is first accessed to or B is first accessed to, although the value copied into W is still A in the end. The attacks of the electromagnetic emission type on the active areas or non-active areas as well as address leakages are thus cancelled. Of course, the same process can be used for copying data B into W.

According to the invention, copying data A or B into the working memory area W is thus, made stronger with respect to the leakages to the outside, since it is hidden and random as regards its execution and independent from the accessed area.

According to another aspect of the invention, the computational part implied in an operation to be carried out on the electronic component is provided to be always the same, as regards information leakage to the outside. For this purpose, it is provided to always use the same memory areas whatever the operation to be executed is, such that the operations have the same hidden signal trace as regards the information leakage outside. In this case, the operations cannot be separated from each other, which results in the fact that an observer does not know which operation is really executed on the electronic component. Advantageously, the configuration of the memory areas involved makes it possible to obtain one operation or another one.

According to an exemplary implementation, the method discussed hereabove, which makes it possible to securely handle data for blocking the attacks of the “covert channel” type, can advantageously be adapted for the implementation of multiplication and square operations used for the modular exponentiation within the scope of a cryptographic algorithm of the RSA type.

Thus, in the case of this example, the multiplication operations (“multiply”) and square operations (“square”) can have the same hidden signal trace since they are equivalent to multiplying a first memory area by a second memory area. If the memory areas are always the same, the hidden signal traces as seen from the outside are identical.

According to an exemplary embodiment, the memory areas R1 and W are the memory areas used for executing one operation. For carrying out the multiplication of A by B, the content of R2 is first copied into W according to the copying principles mentioned hereabove and the content of the memory area R1 is multiplied by the content of the working memory area W. To carry out the square operation on data A, the content of R1 is previously copied into W while still applying the same principles already mentioned and the content of the memory area R1 is multiplied by the content of the working memory area W. The functional difference thus lies in the content copied previously into the working memory area W which access is denied to, for an outside observer, thanks to the previously described copying process. Besides, the memory areas R1 and W involved in the carrying out of the operation are always the same and the hidden signal traces of such operations, as seen from the outside are identical. An observer will then be able to deduce which memory areas are used in fact R1 and W in the example, but he will not be able to know which content A or B has previously been copied into the working memory area W and thus he will not be able to know which operation of the multiplication or the square is carried out.

The working memory area W can previously be set in a random order and/or with random values.

Generally speaking, the method according to the invention is likely to be applied to any algorithm in which the possibility exists of having two distinct memory areas to be applied in a calculation and where an observer from the outside could deduce sensitive information from knowing the areas used, through attacks of the above mentioned type.

The method for securely handling data according to the invention can be implemented by any appropriate hardware or software.

1. A method for handling data between memory areas of an electronic component comprising at least one working memory area for carrying out operations on said component, bringing into play at least one of said data, the method comprising the use of the same memory areas for executing an operation, whatever the operation to be executed is, such that each operation has a hidden signal trace that is identical in terms of location leakage outside said component.

2. A method according to claim 1, further including, prior to the execution of the operation, a step of configuration of the memory areas to be used with data that serves as operands in said operation, said step of configuration of the memory areas depending on the operation to be executed.

3. A method according to claim 2, wherein the step of configuring the memory areas comprises copying one of said data into the working memory area, the copying of said data being hidden and random in its execution.

4. A method according to claim 3, wherein the memory areas containing said data are simultaneously active during the copying of one of said data into the working memory area.

5. A method according to claim 3, wherein the copying of one of said data into the working memory area comprises successively accessing the elements of said data in their respective memory area, in an order which depends on a random variable, and copying said elements into the working memory area while replacing one of the data elements with the data element corresponding to the data which must be copied into the working memory area.

6. A method according to claim 1, wherein the operations carried out are operations required in the scope of the execution of a public-key cryptographic algorithm.

7. A method according to claim 6, wherein the public-key cryptographic algorithm is of the RSA type.

8. A method according to claim 7, wherein the operations are square and multiplication operations serving for modular exponentiation.

9. A method according to claim 1, wherein the method is hardware-executed.

10. A system for carrying out the method according to claim 1, wherein the component is a chip card, a chip card reader or a TPM (Trusted Platform Module).
